(19) United States
(12) Patent Application Publication
(10) Pub. No.: US 2007/0185245 A1
(43) Pub. Date: Aug. 9, 2007

(54) Colorable composition

(76) Inventors: Erik A. T. Trommelen, Amsterdam (NL); Jaques W.M. Damen, Amsterdam (NL)

Correspondence Address: KRATON POLYMERS U.S. LLC, WESTHOLLOW TECHNOLOGY CENTER, 3333 HIGHWAY 6 SOUTH, HOUSTON, TX, 77082, US

(21) Appl. No.: 10/555,125

(22) PCT Filed: Apr. 28, 2004
(86) PCT No.: PCT/EP04/50634

§ 371 Date: May 11, 2006

(30) Foreign Application Priority Data
May 1, 2003 (EP) 03076391.6
Jun. 2, 2003 (EP) 03076726.3
Nov. 13, 2003 (EP) 03104178.3

(51) Int. Cl. C08L 95/00

(52) U.S. Cl. 524/59; 524/505

(57) ABSTRACT

The present invention concerns a colorable composition comprising a bitumen-like compound having a PEN value of at least 30 dmm at 25° C., and comprising at least a hydrogenated petroleum resin (a) or comprising at least a hydrogenated petroleum resin (a) and an oil (b) and a mixture of thermoplastic elastomers comprising:—one or more engineering thermoplastics (c1) having a melt index of I to 50 at 2.16 kg/12300C (determined in accordance with ASTM D1238), and/or a styrenic block copolymer (c2) of formula A-B-A or (A-B)ₙ-X, wherein A stands for a polymer block of a vinyl aromatic monomer, B stands for a polymer block of a conjugated diene monomer, X stands for a coupling moiety, and n stands for an integer of 2 to 20, wherein the weight ratio of (c1) to (c2) varies from 100:0 to 0:100; and—a hydrogenated styrenic block copolymer (d) of formula A-C-A or (A-C)ₙ-X, wherein A, X, and n have the previously given meanings and C stands for a polymer block of a conjugated diene monomer, hydrogenated to an extent of at least 50% wherein the weight ratio of (c), being the total of (c1) and (c2), to (d) varies from 95:5 to 5:95, the total amount of A in block copolymers (c2) and (d) is in the range of from 10 to 45 weight % and wherein the block copolymers have an apparent molecular weight of from 100,000 to 600,000, and the content of said mixture of (c) and (d) being in the range from 5 to 35 wt % based on the composition, and its use as roofing membrane/roofing felt, as well as colored roofing membranes/roofing felts made thereof.

### BACKGROUND ART

The market for single ply polymeric roofing felts is growing. Part of the success is for aesthetical reasons (bright colors) and therefore roofing felt based on the proven bituminous technology with the look of single ply would be highly desirable. Colored roofing felts are a fashion. Such felts or membranes need to meet certain building construction requirements. For instance, they need to provide protection from rain and such like, and have an excellent weatherability. Moreover, such felts should ideally be easy to apply.

There is also a growing market for roofing products that meet stringent requirements for energy conservation. Such roofing products are for instance selected on the basis of emittance and reflectance. For instance, in CALIFORNIA ENERGY COMMISSION Title 24 Proposed Standards for 2005 it is indicated that every roofing product installed in construction to take compliance credit for reflectance and emittance must have a clearly visible packaging label that lists the reflectance and emittance tested in accordance with the test methods of the Cool Roof Rating Council (CRRC-1). Cool roofs are described falling in the category of singly ply products (e.g., white EPDM, white PVC, white CPE, white CPSE or white TPO) or liquid applied products (white elastomeric coatings, white cementitous coatings or white acrylic coatings). According to section 143 of these standards a cool roof should have a minimum initial thermal emittance of 0.75 and a minimum initial solar reflectance of 0.70 reflectance of 0.70+0.34*(0.75−[initial thermal emittance) when tested in accordance with CRRC-1.

The benefits of cool roofs include lower cooling energy, lower peak cooling demand, and potentially longer roof life due to lower surface temperature. In addition to the benefits within the building, a cool roof can reduce temperatures in the local urban environment

The Cool Roof Rating Council (CRRC) was created in 1998 to develop methods for evaluating and labeling both the solar reflectance and the thermal emittance of roofing products, which launched a product-rating program in January 2003. According to the CRRC-1 program, the solar reflectance tests shall be conducted based upon on of the following ASTM test methods: E903, E1918, or C1549. The thermal emittance test shall be conducted based upon one of the following ASTM test methods: C1371 or E408.

From there is known a colorable composition for use as binder in asphalt paving. This reference describes the formulation procedure for synthetic bitumen with the required ingredients to produce a colored binder. Synthetic bitumen is necessary as the ‘black’-asphaltenes present in ‘normal’ bitumen strongly hamper coloration. It has been found however that such a composition does not provide lasting color stability: when applied to a roof as roofing felt, the surface discolors due to the migration/exudation of low molecular weight components of the composition.

From JP 2002206047 there is known a colorable binder composition, principally for paving purposes. Such compositions exhibit excellent weather resistance even when actually used outdoors. On the other hand, such a composition does not exhibit the properties required for roofing felt. In particular low temperature flexibility as well as high temperature resistance is missing.

It is an object of the present invention to provide a colorable composition combining color stability and these low temperature/high temperature properties. In addition, it is an object of the present invention to provide a colorable composition that will meet energy conservation requirements in respect of thermal emittance and solar reflectance

### DISCLOSURE OF INVENTION

Accordingly, there is provided a colorable composition comprising:
a bitumen-like compound having a PEN value of at least 30 dmm at 25° C., and comprising at least a hydrogenated petroleum resin (a) or comprising at least a hydrogenated petroleum resin (a) and an oil (b) and a mixture of thermoplastic elastomers comprising:
   one or more engineering thermoplastics (c1) having a melt index of 1 to 50, preferably from 5 to 25, at 2.16 kg/230° C. (determined in accordance with ASTM D1238) and/or a styrenic block copolymer (c2) of formula A-B-A or (A-B)ₙ-X, wherein A stands for a polymer block of a vinyl aromatic monomer, B stands for a polymer block of a conjugated diene monomer, X stands for a coupling moiety, and n stands for an integer of 2 to 20, wherein the weight ratio of (c1) to (c2) varies from 100:0 to 0:100; and
   a hydrogenated styrenic block copolymer (d) of formula A-C-A or (A-C)ₙ-X, wherein A, X, and n have the previously given meanings and C stands for a polymer block of a conjugated diene monomer, hydrogenated to an extent of at least 50%
      wherein the weight ratio of (c), being the total of (c1) and (c2), to (d) varies from 95:5 to 5:95, the total amount of A in block copolymers (c2) and (d) is in the range of from 10 to 45 weight % and wherein the block copolymers have an apparent molecular weight of from 100,000 to 600,000, and the content of said mixture of (c) and (d) being in the range from 5 to 35 percent by weight (wt %) based on the composition.

The invention also provides the use of the colorable composition for making a roofing membrane or roofing felt as well as the colored roofing membrane or roofing felt made of said composition. With suitably chosen light (white) colored pigments and/or fillers, the invention also provides a colored (white) composition with high emittance and reflectance. Cool roofing products are therefore also within the ambit of the present invention.

The colorable composition may also be used for other (cool) products, for instance as sealant or coating.

### MODE FOR THE INVENTION

Styrenic block copolymers and hydrogenated block copolymers are known in the art Such copolymers are available as triblock copolymers (made sequentially or by coupling a diblock copolymer), as tetrablock copolymers or multiblock copolymers) as linear copolymers and also as branched or radial copolymers (using a multifunctional coupling agent and/or a multifunctional copolymer during its preparation). Such copolymers are typically based on styrene and either butadiene or isoprene or a mixture thereof. However, similar copolymers are obtained using substituted styrenes as monovinyl arenes and/or using C5 to C8 conjugated dienes. Styrenic block copolymers are, for instance available as KRATON® D polymers. Hydrogenation of such block copolymers is also conventional. Such polymers are commercially available as, for instance, KRATON® G polymers.

Typical styrenic block copolymers include SBS (styrene-butadiene-styrene) and SIS (styrene isoprene-styrene), whereas typical hydrogenated styrenic block copolymers include SEBS (styrene-ethylene-butylenestyrene block copolymer) and SEPS (styrene-ethylene-propylene-styrene block copolymers). Those which have a molecular weight of at least 50,000, preferably from 100,000-600,000, a melt index (200° C., 5 kg) of not more than 10 g/10 minutes, a polystyrene content of from 10 to 50% and a specific gravity of at least 0.9 are preferred.

It will be appreciated that block copolymers, prepared by means of coupling of living diblock copolymers by means of a coupling agent and termination of remaining living block copolymers, will finally contain small amounts (e.g., less than 20 mole %) of diblock copolymer.

The apparent molecular weights of the complete block copolymers and each of the intermediate precursors have been determined by Gel Permeation Chromatography using commercially available polystyrene standards (according to ASTM D6474-99).

The styrenic block copolymers and hydrogenated styrenic block copolymers mentioned above may contain functional groups, e.g., by grafting as described in U.S. Pat. No. 4,783,503 or U.S. Pat. No. 4,578,429 (incorporated by reference).

The engineering thermoplastic (c1) used as single component (c) and or in addition to component (c2) may be selected from polyolefins and in particular polyethylene and polypropylene, halogenated polyolefins, chlorosulfonated polyolefins, polyvinyl chloride, EPDM, polystyrene, polyphenylene oxide, PET and analogous poly(alkylene therephthalates). The preferred engineering plastics are atactic polypropylene and EPDM. Components (c1) preferably have a melt index in the range of 5 to 25.

Preferably component (c) is the styrenic block copolymer (c2) mentioned above.

Alternatively, a blend of (c1) and (c2) is used, for instance at a weight ratio of 95:5 to 0:100, more preferably from 50:50 to 0:100. For mixtures with matched viscosities, however, the range can be from very high to very low. Within this selection, for roofing purposes, those components (c1) and/or (c2) should be selected that provide in combination with components (a), (b) if any and (d) a colorable composition having a softening point of from 70° to 180° C.

The bitumen-like compound should have a PEN value of at least 30 dmm at 25° C.

Suitable bitumen-like compounds are disclosed in JP2002-206047A, the contents of which are included herein by reference. Compositions of particular relevance comprise the hydrogenated petroleum resin (a) and an oil (b) with a flash point of 230° C. or above and a paraffinic content of at least 50% and a viscosity of at least 7 mm²/s (100° C.). Preferably, the bitumen-like compound comprises less than 40 wt % of the oil.

In a particularly preferred embodiment the composition comprises a bitumen-like compound comprising from 55 to 75 wt % of the hydrogenated petroleum resin (a); from 15 to 35 wt % of the oil (b); and a mixture of thermoplastic elastomers comprising from 2 to 10 wt % of the block copolymer (c) and from 4 to 14 wt % of the block copolymer (d).

Hydrogenated resins are known in the art and include for instance the resins described in EP 0802251 A.

Preferably, the resins of the present invention have a Ring and BaD softening point, according to test method ASTM E28, of from 500 to 150° C., more preferably of from 60° to 140° C., most preferably of from 95° to 105° C. Regarding its chemical nature, a “resin” according to the present invention may include:

(a) natural and modified rosins, such as, for example, gum rosin, tall-oil rosin, distilled rosin, hydrogenated rosin or otherwise modified rosins;

(b) aliphatic petroleum hydrocarbon resins, the latter resins resulting from the polymerization of monomers comprising primarily olefins and diolefins;

(c) aromatic petroleum hydrocarbons;

(d) aliphatic/aromatic petroleum derived hydrocarbons;

(e) polar or otherwise modified aliphatic and/or aromatic hydrocarbon resins, such as, for example, copolymers and terpolymers of petroleum hydrocarbon resins with vinyl monomers, or mixtures thereof

Mixtures of two or more of the above resins may be required or advantageous for some formulations. Also included are (preferably partially) hydrogenated or hydrotreated derivates of the above resins and any mixture thereof with other (hydrogenated or not hydrogenated, modified or unmodified) resin.

Partially hydrogenated resins are preferred in the present invention. These are available under the trade-name “Regalite® Hydrogenated Hydrocarbon Resin” from Eastman, “Escorezt™)” from Exxon Mobile Chemical, “Arkon™ M” from Arakawa Chemical Ind., and the like.

Hydrogenation of such resins to a degree of at least 70% based on the initial unsaturation is preferred.

As far as the oil is concerned, again the oils disclosed in JP 2002206047 may be used, including both mineral oils and naphthenic oils.

The colorable composition may comprise further components such as pigments and fillers.

In a preferred embodiment, the colorable composition may comprise light colored pigments and/or fillers such as titanium dioxide and/or crushed limestone to achieve high thermal emittance and solar reflectance as well as suitable high and low temperature properties.

### EXAMPLES

The invention is described below by means of examples and comparative examples, but the invention is not limited by these examples and comparative examples.

The examples and comparative examples were prepared in accordance with the combinations indicated in the tables below. The amounts compounded are all indicted in units of wt %. Moreover, the colorable binder compositions for roofing purposes were produced using a homogenizer at a mixing temperature of 180° C., a homogenizer rotation rate of 3,000 rpm with a mixing time of 1 hour. The finished colorable binder compositions for roofing purposes were subjected to needle penetration using the method of ASTM D5 and softening point measurements (R&B: ring & ball) using the methods of ASTM D36 or E28, for PMB's and resins, respectively. The flow and cold bend were measured according to DIN 52123 (August 1985) and UEAtc M.O.A.T. No. 31 (984), respectively.

The binder was formed into a sheet measuring 10 cm×10 cm×3 mm for high temperature flow testing and a sheet measuring 5 cm×20 cm×3 mm for low temperature flexibility testing. Accelerated ageing tests were carried out on the sheets in an air ventilated oven at 80° C.

### Experiment 1

A colorable composition was prepared based on 4.4% SEBS (having a molecular weight of about 190,000), 2.2% SBS (having a molecular weight of about 380,000), 12.1% mineral oil (having a flash point of about 250° C. and a paraffinic content of about 70%), 36.3% of a (90%) hydrogenated petroleum resin. This material had a R&B of 126° C., A PEN at 25° C. of 92 dmm, a PEN at 50° C. of 118 dmm, a DIN flow pass at 100° C. and a cold bend pass at −10° C.

To this composition 35% of limestone (filler) and 10% pigment (titanium oxide and chromium oxide green) were added. The colored composition had a R&B of 132° C., a PEN at 25° C. of 42 dmm, a PEN at 50° C. of 69 dmm, a DIN flow pass at 110° C. and a cold bend pass at −10° C.

The R&B changed from 119 to 120 (2 weeks), 120 (1 month) to 117° C. (2 months) upon aging. Likewise PEN remained nearly the same (82; 84; 86; 96 dmm).

Importantly, the color stability was monitored over the 2 months period. The results show that no difference in color is observed before and after aging. These results demonstrate the color stability of the colored compound, as well as the suitability therefore for roofing purposes.

### Experiment 2

A colorable composition was prepared with light colored pigment to achieve high emittance and reflectance. The composition was based on 4.4% SEBS (having a molecular weight of about 190,000), 2.2% SBS (having a molecular weight of about 380,000), 12.1% mineral oil (having a flash point of about 250° C. and a paraffinic content of about 70%), 36.3% of a (90%) hydrogenated petroleum resin. To this composition 45% of white pigment (titanium dioxide) was added.

The reflectance was determined according to ASTM C1549. The Reflectance of the light colored composition was measured at: 88.4%. The Emittance was determined according to ASTM C1371. The Emittance of the light colored composition was measured at: 0.80.

### TECHNICAL FIELD

The present invention concerns a colorable composition and its use as roofing membrane/roofing felt, as well as colored roofing membranes/roofing felts made thereof.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A colorable composition comprising:
a bitumen-like compound having a PEN value of at least 30 dmm at 25° C., and comprising at least a hydrogenated petroleum resin (a) or comprising at least a hydrogenated petroleum resin (a) and an oil (b) and a mixture of thermoplastic elastomers comprising:
one or more engineering thermoplastics (c1) having a melt index of 1 to 50 at 2.16 kg/230° C. (determined in accordance with ASTM D1238), and/or a styrenic block copolymer (c2) of formula A-B-A or (A-B)ₙ-X, wherein A stands for a polymer block of a vinyl aromatic monomer, B stands for a polymer block of a conjugated diene monomer, X stands for a coupling moiety, and n stands for an integer of 2 to 20, wherein the weight ratio of (c1) to (c2) varies from 100:0 to 0:100; and
a hydrogenated styrenic block copolymer (d) of formula A-C-A or (A-C)ₙ-X, wherein A, X, and n have the previously given meanings and C stands for a polymer block of a conjugated diene monomer, hydrogenated to an extent of at least 50% wherein the weight ratio of (c), being the total of (c1) and (c2), to (d) varies from 95:5 to 5:95, the total amount of A in block copolymers (c2) and (d) is in the range of from 10 to 45 weight % and wherein the block copolymers have an apparent molecular weight of from 100,000 to 600,000, and the content of said mixture of (c) and (d) being in the range from 5 to 35 wt. % based on the composition.

15. The colorable composition of claim 14 wherein the bitumen-like compound comprises the hydrogenated petroleum resin (a) and an oil (b) with a flash point of 230° C. or above and a paraffinic content of at least 50% and a viscosity of at least 7 mm²/s (100° C.).

16. The colorable composition of claim 14 wherein the bitumen-like compound comprises less than 40 wt. % of the oil.

17. The colorable composition of claim 14 comprising:
a bitumen-like compound comprising:
from 55 to 75 wt % of the hydrogenated petroleum resin (a);
from 15 to 35 wt. % of the oil (b) and
a mixture of thermoplastic elastomers comprising:
from 2 to 10 wt. % of the block copolymer (c) and
from 4 to 14 wt. % of the block copolymer (d).

18. The colorable composition of claim 14 wherein (c) is at least one of a styrene-isoprene-styrene block copolymer and a styrene-butadiene-styrene block copolymer.

19. The colorable composition of claim 14 wherein (d) is at least one of a styrene-ethylene-butylene-styrene block copolymer and a styrene-ethylene-propylene-styrene block copolymer.

20. The colorable composition of claim 14 further comprising at least one pigments and fillers.

21. The colorable composition of claim 20 wherein at least part of the pigment is titanium dioxide and at least part of the filler is crushed limestone.

22. The colorable composition of claim 14 comprising both one or more engineering plastics (c1) and block copolymer (c2) in a weight ratio of 5:95 to 95:5.

23. The colorable composition of claim 14 having a softening point of from 70 to 180° C.

24. A roofing felt that comprises a colorable composition comprising a bitumen-like compound having a PEN value of at least 30 dmm at 25° C., and comprising at least a hydrogenated petroleum resin (a) or comprising at least a hydrogenated petroleum resin (a) and an oil (b) and a mixture of thermoplastic elastomers comprising:
one or more engineering thermoplastics (c1) having a melt index of 1 to 50 at 2.16 kg/230° C. (determined in accordance with ASTM D1238), and/or a styrenic block copolymer (c2) of formula A-B-A or (A-B)ₙ-X, wherein A stands for a polymer block of a vinyl aromatic monomer, B stands for a polymer block of a conjugated diene monomer, X stands for a coupling moiety, and n stands for an integer of 2 to 20, wherein the weight ratio of (c1) to (c2) varies from 100:0 to 0:100; and
a hydrogenated styrenic block copolymer (d) of formula A-C-A or (A-C)ₙ-X, wherein A, X, and n have the previously given meanings and C stands for a polymer block of a conjugated diene monomer, hydrogenated to an extent of at least 50% wherein the weight ratio of (c), being the total of (c1) and (c2), to (d) varies from 95:5 to 5:95, the total amount of A in block copolymers (c2) and (d) is in the range of from 10 to 45 weight % and wherein the block copolymers have an apparent molecular weight of from 100,000 to 600,000, and the content of said mixture of (c) and (d) being in the range from 5 to 35 wt. % based on the composition.

25. The roofing felt of claim 24 wherein the colorable composition further comprises at least one of pigments and fillers.

26. The roofing felt of claim 25 wherein at least part of the pigment is titanium dioxide and at least part of the filer is crushed limestone.

27. The roofing felt of claim 26 wherein said roofing felt has a minimum total solar reflectance of 0.7 when tested in accordance with ASTM E903, E1918 or C1549 and a minimum thermal emittance of 0.75 when tested in accordance with ASTMC1371 or E408.

28. A roofing membrane that comprises a colorable composition comprising:
a bitumen-like compound having a PEN value of at least 30 dmm at 25° C., and comprising at least a hydrogenated petroleum resin (a) or comprising at least a hydrogenated petroleum resin (a) and an oil (b) and a mixture of thermoplastic elastomers comprising:
one or more engineering thermoplastics (c1) having a melt index of 1 to 50 at 2.16 kg/230° C. (determined in accordance with ASTM D1238), and/or a styrenic block copolymer (c2) of formula A-B-A or (A-B)ₙ-X, wherein A stands for a polymer block of a vinyl aromatic monomer, B stands for a polymer block of a conjugated diene monomer, X stands for a coupling moiety, and n stands for an integer of 2 to 20, wherein the weight ratio of (c1) to (c2) varies from 100:0 to 0:100; and
a hydrogenated styrenic block copolymer (d) of formula A-C-A or (A-C)ₙ-X, wherein A, X, and n have the previously given meanings and C stands for a polymer block of a conjugated diene monomer, hydrogenated to an extent of at least 50% wherein the weight ratio of (c), being the total of (c1) and (c2), to (d) varies from 95:5 to 5:95, the total amount of A in block copolymers (c2) and (d) is in the range of from 10 to 45 weight % and wherein the block copolymers have an apparent molecular weight of from 100,000 to 600,000, and the content of said mixture of (c) and (d) being in the range from 5 to 35 wt. % based on the composition.
